(19) United States
(12) Patent Application Publication
(10) Pub. No.: US 2003/0002287 A1
(43) Pub. Date: Jan. 2, 2003

(54) Lamp shade structure

(76) Inventor: Mei Ju Juang, Shulin City (TW)

Correspondence Address: BACON & THOMAS, PLLC, 625 SLATERS LANE, FOURTH FLOOR, ALEXANDRIA, VA, 22314

(21) Appl. No.: 09/893,999

(22) Filed: Jun. 29, 2001

(51) Int. Cl. F21V 1/06; F21V 17/00

(52) U.S. Cl. 362/352; 362/450

(57) ABSTRACT

Lamp shade structure including assembling buckles, shade bodies and a tray body. Each assembling buckle has a decorative board and a cooperative stop plate for interconnecting two adjacent shade bodies to form a complete lamp shade. The tray body is connected with all the assembling buckles to reinforce the entire structure for receiving a bulb seat therein. The assembling buckles are detachably assembled with the shade bodies to minimize the volume of the lamp shade so that the transferring and storage of a number of the components are facilitated.

### BACKGROUND OF THE INVENTION

The present invention is related to a lamp shade structure which can be DIY replaceably assembled by a user. The respective components of the lamp shade can be separated from each other to facilitate transferring and storage.

There are various kinds of conventional domestic lamps having lamp shades. The lamp shades are designed with poor structures having shortcomings as follows:

1. The conventional lamp shade is integrally formed or made by welding. When it is desired to change the appearance of the lamp shade, it is necessary to purchase another. This is not economic.

2. The conventional lamp shades have basically identical frame structures without novel design. Such frame structures has a certain structural strength. However, they are connected by welding and cannot be disassembled.

3. The conventional lamp shade has an integrally formed frame. A fabric or paper-made cover sheet is laid on the frame. Such lamp shade has a considerably large volume which makes it difficult to store or transfer a number of lamp shades even the lamp shades are stacked. This leads to increased cost for transferring.

### SUMMARY OF THE INVENTION

It is therefore a primary object of the present invention to provide a lamp shade structure in which the support rods are conveniently detachably assembled with the shade bodies without affecting the rigidity of the lamp shade. Therefore, the volume of the lamp shade can be minimized to facilitate the transferring and storage.

It is a further object of the present invention to provide the above lamp shade in which the respective components can be separated from each other and freely replaced to change the appearance of the lamp shade as desired.

The present invention can be best understood through the following description and accompanying drawings wherein.

### BRIEF DESCRIPTION OF THE DRAWINGS

FIG. 1 is a perspective exploded view of the present invention;

FIG. 2 is a perspective exploded view of a part of the present invention;

FIG. 3 is a perspective assembled view of the present invention;

FIG. 4 is a sectional view of a part of the present invention in one state;

FIG. 5 is a sectional view of a part of the present invention in another state; and

FIG. 6 is a perspective view showing that the components of the present invention are collected to minimize the volume of the lamp shade for easy storage and transferring.

### DETAILED DESCRIPTION OF THE PREFERRED EMBODIMENTS

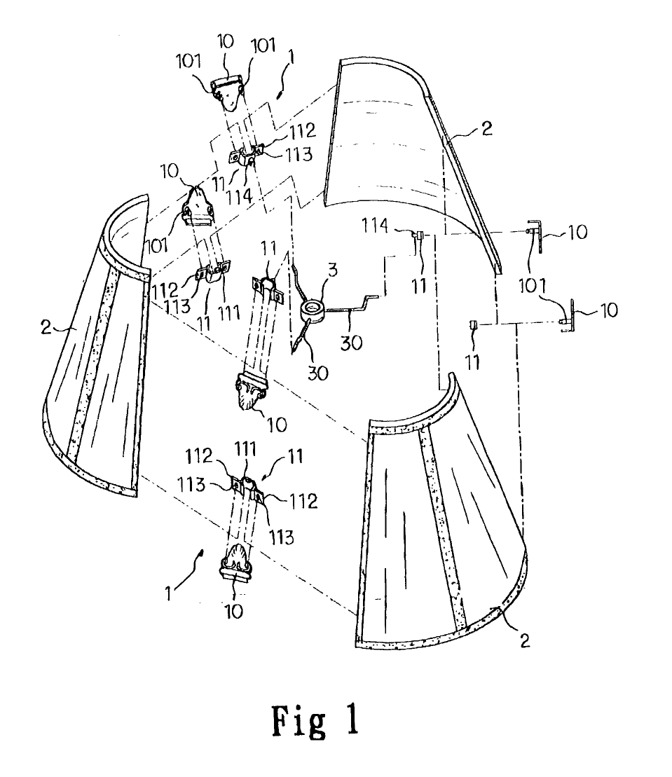

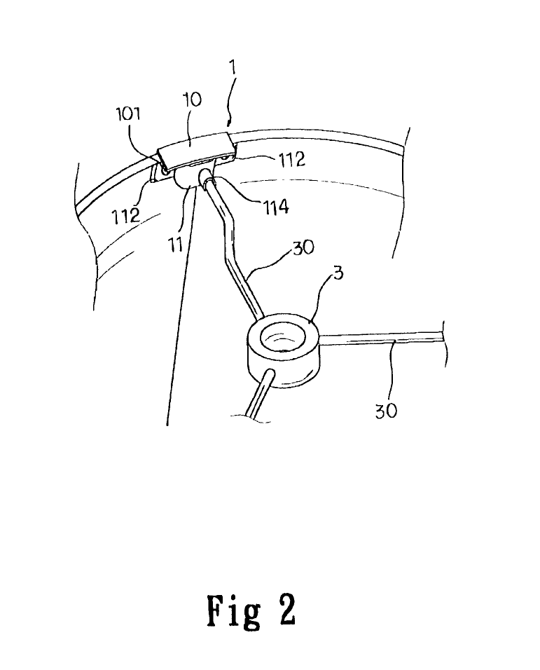

Please refer to FIGS. 1 and 2. The lamp shade structure of the present invention includes assembling buckles 1, shade bodies 2 and a tray body 3.

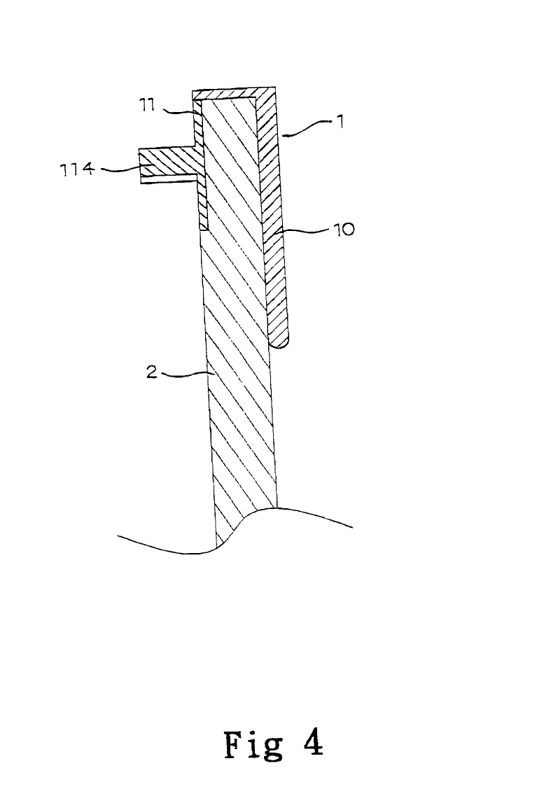

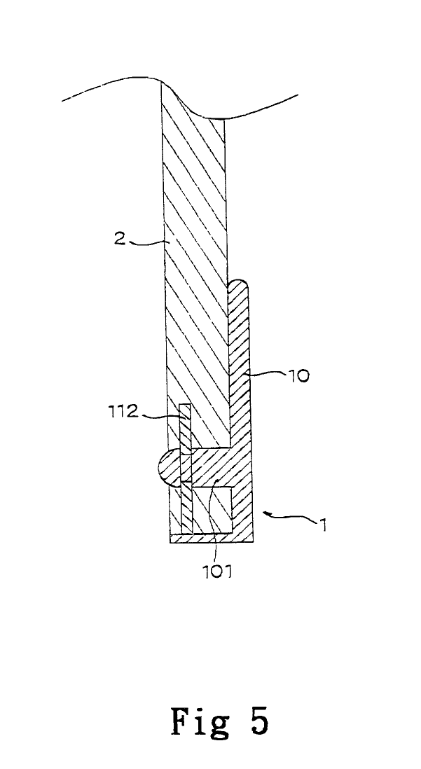

Each assembling buckle 1 has a decorative board 10 and a cooperative stop plate 11. The decorative board 10 freely has different patterns. The end face of the decorative board 10 facing the stop plate 11 is formed with projecting connecting posts 101. The stop plate 11 is formed with a central latch channel 111 with C-shaped cross-section. The opening of the latch channel 111 faces the decorative board 10. Two wings 112 respectively laterally extends from two sides of the latch channels 111. Bach wing 112 is formed with a through hole 113. When assembled, the connecting post 101 is passed through the through hole and engaged therein. The stop plate 11 has different structural patterns according to different connecting positions as shown in FIGS. 4 and 5. In the case that the assembling buckle 1 is positioned on upper side of the lamp shade, an engaging post 114 with C-shaped cross-section projects from the close face of the latch channel 111 of the stop plate 11. In the case of lower side, there is no such engaging post 114.

The assembling buckle 1 is made of flexible material such as plastic or rubber material for more tightly attaching to the shade body 2.

The shade body 2 is made of metal rod and cooperative fabric or paper material and serves to prevent the light from diverging so as to concentrate the light.

The tray body 3 has three bent links 30 projecting from the periphery thereof and containing three angles. The links 30 can be inserted into the engaging post 114 of the assembling buckle 1 to form a firm and stable frame.

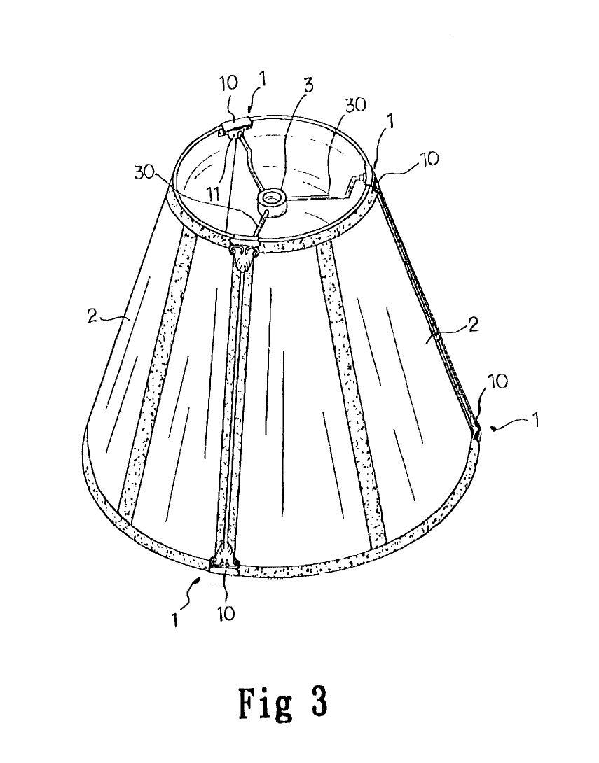

When assembled, the shade bodies 2 are placed side by side and fixedly assembled with each other by the assembling buckles 1. The adjacent edges of two shade bodies 2 are fixedly inserted into the C-shaped latch channel 111 of the stop plate 11 and then the decorative board 10 is attached thereto. The connecting posts 101 are fitted into the through holes 113 of the wings 112 of the stop plate 11 to integrally associate the decorative board 10 with the stop plate 11 so as to firmly clamp the shade body 2. Such procedure is repeated so that all the shade bodies are assembled to form a lamp shade pattern. Then, the links 30 of the tray body 3 are fixedly inserted and located in the engaging posts 114 of the stop plates 11 to make the entire lamp shade structure more rigid without deformation as shown in FIGS. 3, 4 and 5.

The lamp shade can be DIY replaceably assembled by a user.

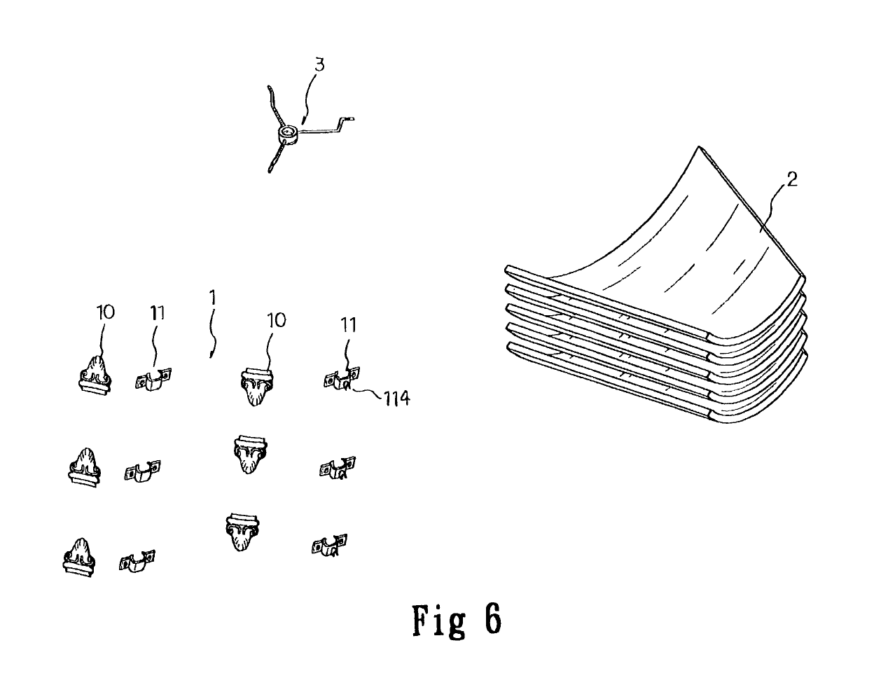

Referring to FIG. 6, prior to assembly, the assembling buckles 1 and shade bodies 2 are separate bodies so that they can be collectively stored to minimize the volume of the lamp shade. In the case of mass-production, the respective components are collected and stored so as to facilitate transferring.

The above embodiments are only used to illustrate the present invention, not intended to limit the scope thereof. Many modifications of the above embodiments can be made without departing from the spirit of the present invention.

What is claimed is:

1. Lamp shade structure comprising assembling buckles, shade bodies and a tray body, said lamp shade structure being characterized in that each assembling buckle has a decorative board and a cooperative stop plate the decorative board having different patterns, the end face of the decorative board facing the stop plate being formed with projecting connecting posts, the stop plate being formed with a central latch channel with C-shaped cross-section. the opening of the latch channel facing the decorative board, two wings respectively laterally extending from two sides of the latch channels, each wing being formed with a through hole. whereby when assembled, the connecting post is passed through the through hole and engaged therein so as to assemble multiple shade bodies with each other.

2. Lamp shade structure as claimed in claim 1, wherein in the assembling buckle positioned on upper side of the lamp shade, an engaging post with C-shaped cross-section projects from the close face of the latch channel of the stop plate, the links of the tray body being fixedly inserted and located in the engaging posts.
